(19) United States
(12) Patent Application Publication
(10) Pub. No.: US 2007/0251020 A1
(43) Pub. Date: Nov. 1, 2007

(54) Fungicidal compositions and methods of using the same

(76) Inventors: George B. Stockman, Collierville, TN (US); David Oppong, Cordova, TN (US)

Correspondence Address: KILYK & BOWERSOX, P.L.L.C., 400 HOLIDAY COURT, SUITE 102, WARRENTON, VA, 20186, US

(21) Appl. No.: 11/789,543

(22) Filed: Apr. 25, 2007

Related U.S. Application Data
(60) Provisional application No. 60/795,864, filed on Apr. 28, 2006.

(51) Int. Cl. C14C 1/00

(52) U.S. Cl. 8/94.15

(57) ABSTRACT

Methods of preventing or inhibiting putrefaction, degradation, and/or deterioration of a surface of wet animal hide or skin are described. The method can include applying a composition containing at least one minimum risk fungicide to the surface or to a solid, liquid or gas that comes in contact with the surface. Treated hides or skin are further described.

This application claims the benefit under 35 U.S.C. §119(e) of prior U.S. Provisional Patent Application No. 60/795,864, filed Apr. 28, 2006, which is incorporated in its entirety by reference herein.

### FIELD OF INVENTION

The present invention relates to fungicidal compositions and methods of using the same. The compositions can be used for protecting hides and skins, such as from putrefaction, degradation and/or deterioration, for instance, caused from uncontrolled fungal growth before, during and/or after tanning, retanning, coloring, fatliquoring, drying, production into crust leather, production into finished leather, after packaging in the wet, tanned state and/or during long periods of storage and shipment, and thereby, preventing, inhibiting, and/or minimizing damage resulting from such growth.

### BACKGROUND OF THE INVENTION

Deterioration of hides and skins, and especially, wet, tanned hides and skins, for instance, due to uncontrolled fungal activity, is a major problem in the leather and tanning industry and a major cause of economic loss. Harmful fungi can come from many sources, including, but not limited to: the animal hide or skin itself, the slaughterhouse, the leather tanning and processing environment, storage containers and warehouses, and the ambient air. Wet, tanned hides and skins can be high in moisture, can have a favourable pH, and/or can have large amounts of available nutrients, permitting the rapid growth of fungi that can seriously damage the hide or skin.

Many of the fungi that can grow on wet, tanned hides or skins can cause damage to the surface of hides or skins in the form of grain destruction and stains due to the formation of colorants created during the life cycle of most fungi.

A common method of protecting products from the detrimental effects of mold is the application of one or more antifungal agents. In the United States, these antifungal agents that are considered pesticides must be registered with the United States Environmental Protection Agency (USEPA) under the Federal Insecticide, Fungicide and Rodenticide Act (FIFRA) and such uses of fungicides must be in strict accordance with the product labels.

The packaging of wet, tanned hides and skins is an important component of a mold control program, protecting the hides and skins from inoculation by active mold organisms and mold spores that can be common in ambient air. Typically, this packaging includes placing a large plastic bag, the “pull-up bag”, on a pallet and piling the tanned hides and skins on top of the plastic bag. Once the desired number of hides or skins has been added to the pallet, the bag can be pulled up around the sides of the pile and then a second cover bag can be pulled down over the pile. The load is normally then stretch wrapped by winding a thin plastic film around the outside of the pile to further protect the pile and help keep the bags and hides or skins in place.

This method of packaging can be helpful in minimizing the exposure of the tanned hides or skins to the ambient air, but it is not 100% effective. The package is not air-tight, and therefore, the contamination of the wet, tanned hides and skins by mold and mold spores from the ambient air is inevitable. Likewise, the hides or skins can be exposed to ambient air after tanning and prior to packaging. This inoculation of the hides and skins with mold and mold spores can become the starting point for uncontrolled mold growth on the substrate.

The standard packaging used for wet, tanned hides and skins provides an ideal environment for the rapid growth of mold. The substrate can contain all of the needed nutrients for mold, including but not limited to, the availability of fats, sugars, minerals and proteins. The hides and skins can be very high in moisture, normally in the range of 40-80% H₂O. The packaging is effective in maintaining the moisture level in the hides and skins during storage and transport, and therefore, ideal conditions for mold growth are maintained throughout the storage/shipment interval.

Infection of the hides and skins, even packaged according to normal industry practice, is the norm. Without the introduction of fungicides, the tanned hides and skins would, in most instances, once infected, become seriously overrun with mold. With nothing to deter the growth of mold, its advance is rapid and serious damage to the surface of the hides or skins can take place in a matter of weeks or even days. Such mold contamination can seriously lessen the commercial value of the tanned hides or skins.

Fungicides, by their design, degrade over time, in order to pass USEPA scrutiny and obtain registration as pesticides under FIFRA. All registered pesticides generally break down in a sufficiently brief period of time, into less toxic degradation products, such that they do not represent an unreasonable burden on the environment.

Certain environmental conditions can be common during packaging, storage and transportation of wet, tanned hides and skins that contribute to the degradation of the fungicide active ingredients intended to protect the substrate from mold. These conditions can include the exposure of the fungicide active ingredients to heat, light, ultraviolet radiation, air, oxidants and other reactants, over extended periods of time. The degradation can be especially apparent at the surface of the pile of wet, tanned hides and skins, where exposure to the ambient air and sunlight takes place, even when packaged according to normal industry standards.

Exposure to air, allowed by the voids in the packaging or through tears in the plastic packaging materials that are commonplace, can be sufficient to inoculate the pile of tanned hides or skins with mold. Once inoculated, if the residual fungicide active ingredient is below the Minimum Inhibitory Concentration (MIC) for the specific mold in question, the mold can grow unchecked, ultimately damaging the hides or skins.

In the past, tanners have been known to spray a fungicide onto the surface of the pile of wet, tanned hides or skins immediately prior to packaging to provide added surface protection during extended storage and/or shipping. This augmentation can be effective in extending the shelf life of the packaged product by increasing the concentration of fungicide active ingredients on the surfaces of the substrate that are exposed to the environment.

Currently, there are very few fungicides registered in the United States for use on tanned hides or skins with label statements that recommend spray application. From time to time, there have been no fungicides for tanned hides with such label statements. Most fungicides are not recommended for spray application onto the surface of wet, tanned hides and skins because of the significant risk of exposure by inhalation, ingestion, or absorption through the skin under the conditions of application. These fungicides typically have significant toxicity, lending to their effectiveness as mold preventative agents and therefore could pose a substantial human risk if sprayed.

There is one classification of pesticides that is accepted by U.S. federal law and associated regulations as inherently safe. In recognition of their widely regarded low toxicity, 31 substances have been specifically exempted from the registration requirements contained in Section 25(b) of FIFRA. These 31 active ingredients, known as “minimum risk pesticides,” are listed in 40 CFR 152.25. This list includes many well known essential oils and other common substances.

These “minimum risk pesticides” have, however, been generally viewed as not being terribly effective as pesticides by the industry. Further, those working in the industry do not consider using these types of pesticides for any particular use, especially long-term protection against fungi. Also, while “pesticides” is a term used by FIFRA to refer to pesticides in general for the treatment of pests, bacteria, and fungi, these selected minimum risk pesticides are not typically viewed as highly effective against fungi and, certainly, there has been no mention of these pesticides for treatment of wet hides and skins.

U.S. Pat. No. 5,403,587 identifies certain essential oils, including thyme oil and others, as effective antimicrobials when used in conjunction with a solubilizing or dispersing agent consisting of an organic solvent and a surfactant to form an aqueous solution or dispersion of the essential oil. U.S. Pat. No. 5,403,587 is limited to sanitizing, disinfecting and cleaning hard surfaces.

U.S. Pat. No. 6,010,993 relates to certain disinfecting compositions for cleaning and disinfecting hard surfaces. The compositions include a peroxygen bleach, glutaraldehyde, an amphoteric surfactant, preferably an amine oxide surfactant and an antimicrobial essential oil. The composition contains other active ingredients in addition to essential oils, most significantly, a peroxygen bleach and glutaraldehyde, both of which have known antifungal properties.

U.S. Pat. No. 6,846,498 relates to an antimicrobial composition, and more particularly, a germicidal spray for sanitizing and disinfecting surfaces. The composition contains a non-aqueous solvent and an “ionizing agent” selected from a group of heavy metal-containing compounds, including copper sulfate, cupric carbonate, or colloidal silver. Such a composition would not be regarded as “minimum risk” by the definition created in FIFRA.

U.S. Published Pat. Application No. US2003/0035852A1 relates to a biorational pesticide and a method of application on trees and plants, fruits and vegetables. The pesticide includes at least one high Terpene containing natural oil and at least one surfactant. The proposed surfactants prevent the composition from being categorized as a minimum risk pesticide.

There are several reported applications of compositions containing one or more of the 31-active ingredients listed in 40 CFR 152.25 in commerce, but they are not formulated solely with ingredients that contain List 4A Inerts which are required for exemption to the registration requirements of FIFRA Section 25(b). (See for example, the following U.S. patents incorporated herein by reference in their entireties: U.S. Pat. Nos. 5,679,351, 6,841,577 and 6,969,522.) None of the compositions have been recommended for use to control fungal growth in fresh, cured, tanned, crusted or finished hides or skins. None of these compositions are fungicidal preparations consisting solely of 40 CFR 152.25 minimum risk pesticide active ingredients and List 4A Inerts, such as is required to make such compositions exempt from the registration requirements of FIFRA Section 25(b).

U.S. Pat. No. 6,548,085 relates to a method of controlling insect pests, by incorporating an essential oil along with either sodium lauryl sulfate or lecithin as a synergist.

More specifically, none of the 31 active ingredients listed in 40 CFR 152.25 have been used as an overspray to augment the protection of packaged wet, tanned hides and skins by increasing the concentration of fungicide active ingredients on the surface of a stack of packaged substrate.

A low-toxicity fungicide that is preferably exempt from FIFRA registration requirements would be highly beneficial to tanners to provide the added protection against fungi on the surface of a pile of wet, tanned hides or skins. Such added protection would result in substantial economic benefit, due to reduced damage from fungal growth during storage and transit and the loss of value that accompanies this damage. Similarly, such exempt formulations would be of substantial benefit to other industries, for the control of fungal growth including mold and yeast, for example, in wood, paper, cloth and other porous and non-porous substrates. An added benefit of such low-toxicity fungicides is that they can be used with minimum risk of adverse human reaction from exposure to such substances.

### SUMMARY OF THE INVENTION

A feature of the present invention is to provide a composition and method for protecting wet, tanned animal hides and skins after tanning from the uncontrolled growth of fungi and the resultant damage to the product that occurs after packaging, during storage, and/or during transport.

The present invention further provides compositions and methods to protect wet, tanned hides and skins from fungal damage that is safe and uses chemical compounds that preferably do not currently require registration as a fungicide under FIFRA.

The present invention further provides compositions and methods to protect wet, tanned hides and skins from fungal damage, that can be used on such hides and skins whether they have been previously treated with a registered fungicide or not.

The present invention further provides compositions and methods to protect wet, tanned hides and skins from fungal damage using compounds that are readily available and will not interfere with the leathermaking process.

The present invention further provides compositions and methods to protect substrates other than wet, tanned hides and skins from fungal damage. Such other substrates include, but are not limited to, the following porous surfaces: wet or dry retanned, colored and fat liquored crust leather, finished leather, paper, wood, cloth, or other substrates. The protection would apply equally to articles containing these porous materials.

The present invention further provides a composition and method to protect wet, tanned hides whereby the described antifungal compounds can be applied by a variety of methods, including, but not limited to: spraying, dipping, roll-coating, soaking, aerosol application or fumigation.

Additional advantages of the present invention will be set forth in part in the description that follows, and in part will be apparent from the description, or may be learned by practice of the present invention. The goals and advantages of the present invention will be realized and attained by means of the representations in the appended claims.

To achieve the above noted goals and in accordance with a purpose of the present invention as embodied and broadly described herein, the present invention provides a method of preventing or inhibiting uncontrolled proliferation of fungi on the surface of wet, tanned hides or skins and the resulting damage incurred after packaging and storage for extended periods. The method includes applying at least one minimum risk fungicide to the surface of the wet, tanned hide or skin and/or to a fluid or solid surface that contacts the animal skin or hide and/or to the airspace surrounding the hide or skin.

The present invention also provides a method of preventing or inhibiting putrefaction, degradation, and/or deterioration of a surface of wet animal hide or skin. The method comprises applying a composition comprising at least one minimum risk fungicide to the surface or to a solid, liquid or gas that comes in contact with the surface, in an effective amount to inhibit or prevent putrefaction, degradation, and/or deterioration of said surface.

The present invention further provides a composition containing at least an aqueous dipping, soaking or spraying solution, wherein at least one animal skin or hide can be dipped, soaked or sprayed, wherein the dipping or soaking or spraying solution contains at least one minimum risk fungicide.

The present invention further provides a treated animal skin or hide comprising at least one animal skin or hide treated with at least one minimum risk fungicide.

It is to be understood that both the foregoing general description and the following detailed description are exemplary only and are not restrictive of the present invention, as claimed. All patents, patent applications, and publications mentioned above and throughout the present application are incorporated in their entirety by reference herein.

### DETAILED DESCRIPTION OF THE PRESENT INVENTION

According to various embodiments, the present invention relates to a method of treating hides or skins, such as wet, tanned hides or skins, with at least one minimum risk fungicide to prevent or inhibit the uncontrolled growth of fungi and the ensuing damage that can result.

As used herein, the terms “hide,” “animal hide,” “skin,” and “animal skin” are all used interchangeably to refer to the flayed or stripped skin or outer layer of an animal, particularly of an animal whose skin is useful for converting into leather. Examples of animals from which skin can be taken to make leather include, but are not limited to: cattle, pigs, deer, kangaroos, goats, camels, sheep, horses, alligators, crocodiles, snakes, birds, seals, eel, fish and walrus. The term “hide or skin” is intended to refer to a hide or skin at any stage of processing after it is removed from a carcass, including any intermediate stage in leather processing or preservation.

As used herein, the terms “wet, tanned hide,” “wet, tanned skin,” “tanned hide,” and “tanned skin” are all used interchangeably to refer to a hide or skin that has been modified by reaction with any tanning agent, to yield a stable, partially processed, intermediate or finished product that usually does not putrefy under normal storage conditions and will withstand exposure to heat without a significant deterioration as long as the shrinkage temperature is not exceeded. The reference to “wet” does mean a product that is not a finished dry leather product that a consumer would buy and use, and the “wet” refers to a hide or skin in a wet or moist state prior to being formed/dried into crust leather.

As used herein, the term “minimum risk pesticide” means any of the combination of 31 active and inert ingredients, specifically listed in 40 CFR 152.25 as exempt from the registration requirements of FIFRA.

As used herein, the term “minimum risk fungicide” means any minimum risk pesticide, used specifically according to the present invention, for the purpose of controlling the proliferation of fungi.

As used herein, the terms “fungicidal preparation” and “minimum risk fungicide” are used interchangeably. The term “composition” according to the present invention means a composition comprising at least the fungicidal preparation.

As used herein, the terms “mold” and “yeast” refer to any fungus genus and species that can contaminate: hides or skins, wet, tanned hides or skins, wet, retanned, colored and fatliquored leather, crust leather or finished leather; other porous substrates including paper, wood or cloth; and articles containing these porous materials.

The methods of the present invention can be carried out at any time after an animal dies or is slaughtered and its skin or hide is flayed or stripped from the animal carcass. In typical leather processing, for example, an animal skin or hide is detached from a fallen or slaughtered animal, and then the animal skin or hide is cleaned, cured, soaked, treated for removal of flesh and hair, bated, pickled and tanned to form leather. Subsequent to tanning, the skin or hide can be wrung to remove excess moisture, usually followed by splitting and shaving to separate the hide into layers and modify each of the layers to the desired thickness. These layers can then be retanned, colored and fatliquored to further modify the skin or hide to build in some of the desired properties of the finished product. Following retanning, coloring and fatliquoring, the skins and hides can be piled or horsed, set out or sammed, and dried to create crust leather. The crust leather can be finished using a wide variety of techniques that are selected and performed to impart specific end product attributes. The skin or hide can be stored or transported to another location after flaying and before the beginning of leather processing, after tanning and wringing, after retanning, coloring and fatliquoring, after manufacture into crust, or after manufacture into finished leather. Many variations of these processes can be used. The method of the present invention can be carried out at the same time as any of these processes or can be carried out as a separate step between any of these processes. For example, a skin or hide can be treated with a minimum risk fungicide before, during, and/or after any of the steps of tanning, wringing, retanning, coloring and/or fatliquoring. Moreover, the method of the present invention is not limited to leather processing and can be combined with any other means of processing a skin or hide. Further, the method of the present invention can be applied to articles containing leather and/or other porous substrates.

In various embodiments of the methods of the present invention, a composition is provided comprising at least one minimum risk pesticide that can be applied to at least a surface of an animal skin or hide, is part of a solid, liquid, or gas that contacts at least a surface of the skin or hide, can be applied to a surface that comes into contact with at least a surface of the skin or hide and/or to the airspace that contacts at least a surface of the skin or hide, in order to prevent or inhibit putrefaction, degradation and/or deterioration of the skin or hide, such as preventing or inhibiting the growth of fungus, such as mold or yeast. Such a composition can be applied in a like manner to other porous substrates including paper, wood, or cloth, or can be applied to finished articles containing such substrates to prevent or inhibit the growth of fungus, such as mold or yeast.

The composition(s) of the present invention, used in the methods described herein, comprises at least one of the following active components: castor oil (U.S.P. or equivalent), cedar oil, cinnamon, cinnamon oil, citric acid, citronella, citronella oil, cloves, clove oil, corn gluten meal, corn oil, cottonseed oil, dried blood, eugenol, garlic, garlic oil, geraniol, geranium oil, lauryl sulfate, lemongrass oil, linseed oil, malic acid, mint, mint oil, peppermint, peppermint oil, 2-phenethyl propionate (2-phenylethyl propionate), potassium sorbate, putrescent whole egg solids, rosemary, rosemary oil, sesame (includes ground sesame plant), sesame oil, sodium chloride (common salt), sodium lauryl sulfate, soybean oil, thyme, thyme oil, white pepper, or zinc metal strips (zinc metal and impurities), or combinations thereof. Each of these components are considered minimum risk pesticide active ingredients and are used in minimum risk fungicides for purposes of the present invention. Two or more, three or more, four or more, five or more, and so on of the components can be used together in a composition. The one or more minimum risk fungicide active ingredients can be present in a composition or formulation in an effective amount to inhibit or prevent the growth of at least one fungus. In addition or alternatively, the one or more minimum risk fungicide active ingredients can be present in an effective amount to inhibit or prevent putrefaction, degradation, and/or deterioration of a surface, such as a wet animal hide or skin. For example, the concentration of at least one minimum risk fungicide active ingredient can be from about 0.01 wt % to about 100 wt %, or from about 0.5 wt % to about 10 wt %, or from about 1 wt % to about 10 wt % based on the overall weight of the composition or formulation. The application rate of the formulation or composition containing at least one minimum risk fungicide active ingredient can be any amount, again, effective to prevent or reduce the growth of at least one fungus and/or in an effective amount to inhibit or prevent putrefaction, degradation, and/or deterioration of a surface, such as a wet animal hide or skin. The application rate can be, for instance, from about 0.25 to about 100 pounds of said composition or formulation per about 3,000 pounds of wet hides or skins. Other examples include from 1 to 75 pounds, from 5 to 50 pounds, from 10 to 50 pounds, from 20 to 50 pounds of said composition or formulation per 3,000 pounds of wet hides or skins. Further application rates can be used below or above this range.

The minimum risk fungicide actives that can be used in the compositions of the present invention can be combined or compounded or otherwise used in combination with a wide array of inerts or inert ingredients which can be “minimal risk inerts” to aid in the delivery of the minimum risk fungicide to treat the hide or skin or other substrate. A complete list of these minimal risk inert ingredients has been developed by the USEPA as part of its policy on toxic inert ingredients in pesticide products and can be found in the Federal Register at: 59 FR 49400 (Sep. 28, 1994) identified as “List 4A”. The inert ingredient can include any substance commonly consumed as food. The inert ingredient(s) can be:
Sorbitol
L-Ascorbic acid
Dextrose
Glycerol (glycerin) 1,2,3 propanetriol
Hexedecanoic acid
Stearic acid
Urea
Sugar
Acetic acid, calcium salt
D-
(+)-Lactose
Citric acid, trisodium salt
Citric acid
Lactic acid, ethyl ester
Fumaric acid
Isopropyl myristate
9-Octadecenenoic acid (Z)-,2,3-dihydroxypropyl ester (9CI)
Oleic acid
Vanillin
Butyl stearate
Carbon dioxide
Acetic acid, potassium salt
Acetic acid, sodium salt
Ascorbyl palmitate
Lactic acid, n-butyl ester
Dodecanoic acid, 2,3-dihydroxypropyl ester
Dodecanoic acid
9-Octadecenoic acid (9Z)-, potassium salt
9-Octadecenoic acid (9Z)-, sodium salt
Citric acid, disodium salt
Carbonic acid, monosodium salt
Carbonic add, monopotassium salt
Calcium carbonate
Senzoic acid, sodium salt
Tetradecanoic acid
Carbonic acid, magnesium salt (1:1)
Benzoic acid, magnesium salt
Octadecanoic acid, magnesium salt
Octadecanoic acid, zinc salt
Benzoic acid, potassium salt
Tetradecanoic acid, 2,3-dihydroxypropyl ester
Octadecanoic acid, potassium salt
Potassium octoate
Citric acid, calcium salt (2:3)
Octadecanoic add, sodium salt
Citric acid, monopotassium salt
Citric acid, tripotassium salt
Citric add, sodium salt
Octadecanoic acid, ammonium salt
Bentonite
Iron oxide (Fe2O3)
Magnesium oxide
Zinc oxide
Hematite (Fe2O3)
Iron oxide (Fe3O4)
Limestone
Vermiculite
Zeolites (excluding erionite (CAS Reg. No. 56733-21-9))
Montmorillonite
Octodecanoic acid, diester with 1,2,3-propanetriol (9CI)
Mullite
Aluminum magnesium silicate
Aluminum potassium silicate
Pumice
Kaolin
Silicic acid, aluminum salt
Silicic add, magnesium salt
Magnesium silicate, hydrate
Silicic acid, aluminum sodium salt
Silicic acid, calcium salt
Iron oxide (FeO)
Soapbark (Quillaja saponin)
Vitamin E
Octadecanoic acid, calcium salt
Benzoic acid, ammonium salt
Octanoic acid, sodium salt
Benzoic acid, calcium salt
Citric acid, dipotassium salt
9-Octadecenoic acid, 12-hydroxy-, monosodium salt, (9Z,12R
Calcium acetate, monohydrate
Citric acid, monohydrate
Citric acid, tripotassium salt, monohydrate
Calcium octanoate
Citric acid, trisodium salt, dihydrate
Citric acid, trisodium salt, pentahydrate
Malic acid
Carbon
Potassium chloride
Sulfuric acid, magnesium salt (1:1)
9-Octadecenoic acid, 12-hydroxy-, monopotassium salt, (9Z,
Silicon dioxide (crystalline-free forms only)
Potassium bisulfate
Sodium chloride
Citric acid, calcium salt (2:3)
Silica, amorphous, precipitated and gel
Sulfur
Nitrogen
Sulfuric acid, disodium salt, decahydrate
Water
Sulfuric acid, disodium salt
Sulfuric acid, calcium salt (1:1)
Citric acid, potassium salt
Sulfuric acid, dipotassium salt
Graphite
Soybean oil
Safflower oil
Olive oil
Linseed oil (unboiled)
Cottonseed oil
Corn oil
Coconut oil
Castor oil, hydrogenated
Castor oil
Peanut oil
Sperm oil
Cocoa
Lecithins
Malt extract
Paraffin wax
Palm oil
Lanolin
Wheat germ oil
Almond oil
Sesame seed oil
Beeswax
Invert sugar
Carnauba wax
Fish oil
Hydrogenated soybean oil
Honey
Corn syrup
Lecithins, soya
Fuller's earth
White mineral oil (petroleum)
Molasses
Carrageenan
Cellulose, carboxymethyl ether
Guar gum
Carob gum (locust bean gum)
Polyethylene
Cellulose carboxy methyl ether, sodium salt
Cellulose
Cellulose acetate
Dextrins
Cellulose, 2-hydroxyethyl ether
Cellulose, 2-hydroxypropyl ether
Cellulose, 2-hydroxypropyl methyl ester
Cellulose, methyl ether
Cornstarch
Sodium alginate
Rubber
1,2,3-Propanetriol, homopolymer (9Z)-9-octadecenoate
1,2,3-Propanetriol, homopolymer, octadecanoate
Maltodextrin
Calcium sulfate, hemihydrate
Magnesium sulfate heptahydrate
Calcium sulfate, dihydrate
Silica, hydrate
Octodecanoic acid, ester with 1,2,3-propanetriol (9CI)
Xanthan gum
Mica group minerals
Lime (chemical) dolomitic
Mica
Silicic acid (H4SiO4), aluminum sodium salt (1:1:1)
Zinc iron oxide
Iron magnesium oxide (Fe2MgO4)
Calcium oxide silicate (Ca3O(SiO4))
Magnesium oxide silicate (Mg3O(Si2O5)2), monohydrate
Iron oxide (Fe2O3), hydrate
9-Octadecanoic acid, monoester with oxybis (propanediol)
Silicic acid, aluminum potassium sodium salt
Gypsum
Carbonic acid, calcium salt (calcite)
Tetradecanoic acid, potassium salt
Silicic add (H2SiO3), magnesium salt (1:1)
Wollastonite (Ca(SiO3))
Magnesium silicon oxide (Mg2Si3O8)
Dolomite (CaMg(CO3)2)
Citric acid, monosodium salt
Potassium sorbate
9-Octadecanoic acid (9Z)-monoester with 1,2,3 propanetriol
9-Octodecenoic acid (9Z)-, diester with 1,2,3-propanetriol (9CI)
Decanoic acid, monoester with 1,2,3-propanetriol
Octanoic acid, monoester with 1,2,3-propanetriol
Plaster of Paris
Hexadecanoic acid, diester with 1,2,3-propanetriol (9CI)
Hexadecanoic acid, monoester with 1,2,3-propanetriol
Tetradecanoic acid, monoester with 1,2,3-propanetriol (9C
Dodecanoic acid, monoester with 1,2,3-propanetriol (9CI)
Dodecanoic acid, diester with 1,2,3-propanetriol (9CI)
Octodecanoic acid, monoester with 1,2,3-propanetriol (9CI)
Octanoic acid, diester with 1,2,3-propanetriol (9CI)
Nepheline syenite
9-Octadecenoic acid, ester with 1,2,3-propanetriol
Cellulose, mixture with cellulose carboxymethyl ether, sodium salt
Tetradecanoic acid, diester with 1,2,3-propanetriol (9CI)
Decanoic acid, diester with 1,2,3-propanetriol (9CI)
Silica, vitreous
Tallow
Cork
Lard
Diatoinaceous earth (less than 1% crystalline silica)
Silica Gel
Lactose, monohydrate
Cellulose, pulp
Humic acid sodium salt
Meat meal
Corn syrup solids
Hydrogenated cottonseed oil
Bone meal
Cottonseed meal
Cellulose, regenerated
Feldspar group minerals
Glue (as depolymerized animal collagen)
Cane syrup
Humic acid, potassium salt
Hydrogenated palm oils
Citrus pulp, orange
Corn flour
Rice bran oil
Yeast
Coffee grounds
Licorice extract
Oils, wheat
Wintergreen oil
Sunflower seeds
Zeolites, NaA
Paprika
Gellan gum (tolerance pending approval)
9 Octadecenoic acid, mono ester with tetraglycerol
Hydrogenated rapeseed oil
Bentonite, sodian
Perlite, expanded
Silica gel, precipitated, crystalline-free
Silica, amorphous, fumed (crystalline free)
Canola oil
Perlite
Oat protein
Animal feed items conforming to 40 CFR 180.950(b)
Animal glue
Cardboard
Cat food
Clam shells
Commonly consumed food commodities conforming to 40
CFR 180.950(a)
Cotton
Douglas fir bark
Edible fats and oils conforming to 40 CFR 180.950(c)
Egg shells
Oyster shells
Paper
Peat moss
Sawdust
Vinegar (maximum of 8% acetic acid in solution)

Any combination of inert ingredients can be used. Any substance commonly consumed as food can be used.

Additional substances that can be present in the composition include other actives, inerts, vehicles, solvents, dispersants, emulsifiers, adjuncts, carriers and/or other ingredients. One or more of these substances can be introduced into the composition in any manner, such as by compounding and like methods. These additional substances can be used in conventional amounts, such as from about 0.1% to about 90% by weight of the composition, such as 0.1% to 70% by weight, 1% to 50% by weight, or 5% to 30% by weight.

The composition of the present invention includes one or more of the above mentioned minimum risk fungicide active ingredients that are preferably exempt from FIFRA registration, and optionally one or more other additives that can preferably comply with the exemption requirements.

A class of compounds known as potentiators can also be used in conjunction with fungicides to modify the conditions in the tanned hides or skins, such that the fungicide(s) active ingredients will have their optimal impact on a fungus, including mold and yeast.

More than one minimum risk fungicide can be used at one time, at different times, or sequentially, or in any combination. According to various embodiments, the compositions according to the present invention can be used to treat any hide or skin previously untreated with an antifungal agent or already treated with a chemical or a combination of chemicals that can be non-minimum risk fungicides.

In at least one embodiment of the present invention, one or more minimum risk fungicides of the present invention can be used in combination with one or more non-minimum risk fungicides, such as conventional fungicides, for example, Prosan™ 18 fungicide from Buckman Laboratories International, Inc. The minimum risk fungicides of the present invention can be used by adding one or more minimum risk fungicides to the non-minimum risk fungicide(s). The one or more minimum risk fungicides of the present invention can be used prior to, during, or after application of a non-minimum risk fungicide(s). The minimum risk fungicide(s) can have the ability to reduce the amount of non-minimum risk fungicide used previously for purposes of controlling the growth of one or more fungi. The one or more minimum risk fungicides of the present invention can be applied or otherwise treat the substrate by treating the substrate at the same time with the non-minimum risk fungicide(s), sequentially with the non-minimum risk fungicide(s), or in any other order of treatment.

As used herein, to inhibit the uncontrolled growth of fungi and the ensuing damage of hides or skins that can result refers to any reduction in the proliferation of at least one fungus, e.g., mold or yeast, on the surface of hides or skins, or the resulting damage, and is not meant to impose a requirement that the substrate will be completely void of a fungus, like mold or yeast or their spores. It is not required to produce a substrate that is sterile with respect to a fungus, like mold or yeast, but rather to control their growth, such that damage to the hide or skin is minimized, reduced, and/or stopped.

The present invention provides a method for controlling the growth of at least one fungus in or on a product, material, or medium susceptible to supporting growth of at least one fungus, such as animal hides and/or skins, which can be wet animal hides and/or skins. This method includes the step of adding to (or otherwise treating) the product, material, or medium a composition of the present invention in an amount effective to control the growth of at least one fungus. The effective amount varies in accordance with the product, material, or medium to be treated and can, for a particular application, be routinely determined by one skilled in the art in view of the disclosure provided herein. The compositions of the present invention are useful in preserving or controlling the growth of at least one fungus in various types of industrial products, media, or materials susceptible to attack by at least one fungus. Such media or materials include, but are not limited to, for example, dyes, pastes, wood surfaces, porous or non-porous surfaces/materials, lumber, leathers, textiles, pulp, wood chips, tanning liquor, paper mill liquor, polymer emulsions, paints, paper and other coating and sizing agents, metalworking fluids, geological drilling lubricants, petrochemicals, cooling water systems, recreational water, influent plant water, waste water, pasteurizers, retort cookers, pharmaceutical formulations, cosmetic formulations, and toiletry formulations. The composition can also be useful in agrochemical formulations for the purpose of protecting seeds or crops against fungal spoilage.

The compositions of the present invention can be used in a method for controlling the growth of at least one fungus in or on a product, material, or medium susceptible to attack by at least one fungus. This method includes the step of adding to the product, material, or medium a composition of the present invention, where the components of the composition are present in effective amounts to control the growth of at least one fungus.

As stated earlier, the compositions of the present invention are useful in preserving various types of industrial products, media, or materials susceptible to attack by at least one fungus. The compositions of the present invention are also useful in agrochemical formulations for the purpose of protecting seeds or crops against algal spoilage. These methods of preserving and protecting are accomplished by adding the composition of the present invention to the products, media, or materials in an amount effective to preserve the products, media, or materials from attack by at least one fungus or to effectively protect the seeds or crops against fungal spoilage. According to the methods of the present invention, controlling or inhibiting the growth of at least one fungus includes the reduction and/or the prevention of such growth.

It is to be further understood that by “controlling” (e.g., preventing) the growth of at least one fungus, the growth of at least one fungus is at least partially inhibited. In other words, there is preferably no growth or essentially no growth of at least one fungus. “Controlling” the growth of at least one fungus maintains the microorganism population at a desired level, reduces the population to a desired level (even to undetectable limits), and/or inhibits the growth of at least one fungus.

According to various embodiments, the compositions according to the present invention can comprise a carrier liquid, such as water, to form a mixture that can be directly applied to the hide or skin. Other carrier liquids can be used as long as the liquid does not negatively affect the activity of the fungicide. The carrier liquid can be non-aqueous or aqueous. The amount of the carrier liquid or solvent can be any suitable amount. For instance, the amount of the carrier liquid or solvent can be from about 0.1 wt % to 99 wt %, by weight of the overall composition, such as from about 1 wt % to about 90 wt %, by weight of the overall composition, or from about 10 wt % to about 70 wt % by weight of the composition. For purposes of the present invention, reference to “composition” with respect to the minimum risk fungicide can be considered a “formulation,” and the term “composition” is, for purposes of the present invention, intended to include a formulation, mixture, and the like.

Optionally, the composition can include a gas, such as but not limited to, carbon dioxide, (or other inert gases or other gases that do not adversely affect the substrate or material being treated) to form a gaseous mixture that can be used to saturate the airspace surrounding the hide or skin, either temporarily or for an extended period of time, such as during storage and shipping. Liquid carbon dioxide can be used as a solvent for the minimum risk pesticide, providing the vehicle for fumigating the packaged hides or skins, including any storage container or any storage space in which a hide or skin is located. Such a storage space can include, but is not limited to, a warehouse or a shipping container. Solid carbon dioxide can also be used as a carrier for a minimum risk fungicide. In this latter example, a minimum risk fungicide can be dissolved in liquid carbon dioxide under pressure and the solution can be atomized through a nozzle, as happens with a CO₂ fire extinguisher, and sprayed on the hide or skin. As the solid carbon dioxide-minimum risk fungicide mixture sublimes, a residue of minimum risk fungicide can be present on the surface to provide protection against at least one fungus, like mold or yeast. Optionally, the composition can be applied as a solid. The composition can be a solid in its natural state, e.g., corn gluten meal, or it can be compounded with a solid carrier, e.g., bentonite, laponite, or other particulate carriers to yield a solid product that can be applied to the surface of the hide or skin. The solid can be any shape or form and, more preferably, is a particulate or powder which can be easily mixed or combined with at least one minimum risk fungicide active. The solid can be inert to the overall composition or can be one of the inert ingredients that are solids mentioned above. The amount of the solid present in the overall composition can be the same amounts mentioned above with respect to the liquid carrier or solvent.

When one or more of the minimum risk fungicides are applied to the surface of wet, tanned hides or skins, including the exposed surfaces of a pile of hides or skins, in excess of the Minimum Inhibitory Concentration (MIC) for fungi commonly encountered in leather manufacturing, the protection can be improved on the surface of the pile. Under such conditions, the normal exposure of the hides or skins, such as to fungi and/or fungal spores, can prevent uncontrolled fungal proliferation and the damage that comes with it. In one or more embodiments of the present invention, the compositions or formulations of the present invention can provide control of one or more fungi for a period, such as from one week to six months or any time period in between, such as two weeks, three weeks, four weeks, five weeks, six weeks, seven weeks, eight weeks, up to six months or more. During one or more of these time periods, the growth of at least one fungi is controlled such that there is no growth, or the growth is so slight that there would essentially be no damage or proliferation of the fungus. More than one fungus can be controlled by the compositions of the present invention.

The compositions can be applied to a hide or skin (or other substrate or area) by essentially any method in which a substance can be applied to a substrate. Such methods can include, but are not limited to: dipping, spraying, spreading, rolling, dusting, sprinkling, fogging and gassing. Spray devices that can be useful in such applications include, but are not limited to, any device in which a fluid can be passed through an orifice under pressure, either with air or without air. Such a device can be as simple as a conventional pump-up garden sprayer, or as sophisticated as a high pressure-low volume (HPLV) spray machine. For example, the compositions of the present invention can be applied or used to treat a substrate or area containing the substrate as a solid, liquid, and/or gas or vapor. For instance, the compositions of the present invention can be applied as a vapor, such as in a confined area. As a further example, the composition, whether in a solid, liquid, gas, or vapor state, can be applied to the substrate or area in a closed environment to significantly improve antifungal protection, for instance, of substrates like wet, tanned hides or finished leather or leather goods. This can be done, for instance, by the closed environment being a pallet of plastic-enclosed wet, tanned hides, for example, or a container of finished leather or finished leather goods. The compositions of the present invention can be applied using a static diffuser, such as the type of diffusers used in air freshener products. A small reservoir containing a suitably formulated solution or gel of the compositions of the present invention, along with a semi-permeable membrane through which the compositions can slowly escape into the surrounding air or environment can be used in the present invention. Further, pellets or other solid shapes can be used or gels formed into various shapes can be used to disperse or treat a substrate or a given area, such as a closed environment like a pallet containing wet, tanned hides, for example. The solid or gel can be placed in a suitable diffuser or other device and/or the solid or gel containing the compositions of the present invention can be otherwise applied to an area or particular substrate by other techniques, such as placing the solid at the bottom of the pallet, on the plastic, or incorporated within the plastic or other sheet or cover which covers the wet, tanned hides. For instance, the plastic or polymer or other material used to form the cover can have a layer which contains the composition of the present invention or the material used to form the cover can itself contain the compositions of the present invention and provide a controlled release of the composition within the closed environment. The solid or gel can alternatively or in addition be sprinkled or otherwise applied on the leather or areas around the leather or other substrates to be treated. Essentially, any means of applying the compositions of the present invention can be used herein.

The present invention will be further clarified by the following examples, which are intended to be exemplary of the present invention.

### EXAMPLE 1

Various substances, as shown in Table 1, were screened for anti-fungal activity by incorporating them in mineral-salts glucose medium of the following composition: 0.7 g of KH₂PO₄; 0.7 g of MgSO₄.7H₂O; 1 g of NH₄NO₃; 0.005 g of NaCl; 0.002 g of FeSO₄.7H₂O; 0.002 g of ZnSO₄.7H₂O; 0.001 g of MnSO₄.7H₂O; 10 g of Glucose; 100 ml of water. The pH of the medium was adjusted to 6 with 1N NaOH. The medium was distributed in 50 ml amounts into 250 ml flasks and autoclaved at 121° C. for 20 minutes. The test fungus, Aspergillus niger, was grown on potato dextrose agar for 7-10 days. A spore/hyphal suspension of the fungus was prepared by washing down the spores/hyphae from the slant with sterile saline into a bottle containing 30 ml sterile saline and shaken. The chemicals were added to the sterile mineral-salts medium in the desired concentrations, and each flask was inoculated with a suspension of the fungal suspension to give a final fungal count of approximately 1×10⁶ cfu/ml. The inoculated samples were incubated at 25° C. and inspected visually for growth or no growth at 7 and 14 days.

TABLE 1
Antifungal efficacy of various treatments of wet,
tanned cattlehide against Aspergillus niger:

| | CONCENTRATION | GROWTH | |
|---|---|---|---|
| COMPOUND | (BY WT.) | 7-days | 14-days |
| 2-Phenylethyl propionate | 1% | − | − |
| Garlic oil | 1% | − | − |
| Garlic oil | 0.5% | − | − |
| Geraniol | 1% | − | − |
| Geraniol | 0.5% | − | − |
| Peppermint oil | 1% | − | − |
| Peppermint oil | 0.5% | − | − |
| Linseed oil | 1% | ++++ | |
| Rosemary oil | 1% | − | − |
| Rosemary oil | 0.5% | − | − |
| Cinnamon oil | 1% | − | − |
| Cedar wood oil | 1% | ++++ | |
| Eugenol | 1% | − | − |
| Eugenol | 0.5% | − | − |
| Geranium oil | 1% | ++++ | |
| Citric acid | 1% | − | − |
| Citric acid | 0.5% | − | − |
| Sodium lauryl sulfate | 1% | − | − |
| Sodium lauryl sulfate | 0.5% | − | − |
| Thyme oil | 1% | − | − |
| Thyme oil | 0.5% | − | − |
| Sesame oil | 1% | ++++ | |
| Lemongrass oil | 1% | − | − |
| Lemongrass oil | 0.5% | − | − |
| Clove oil | 1% | − | − |
| Clove oil | 0.5% | − | − |
| Citronella | 1% | − | − |
| Citronella | 0.5% | − | − |
| Sodium dehydroacetate* | 1% | − | − |
| Sodium dehydroacetate* | 0.5% | − | − |
| Sodium benzoate | 1% | + | |
| Sodium benzoate | 0.5% | ++ | |
| Potassium sorbate | 1% | − | − |
| Potassium sorbate | 0.5% | − | +++ |
| Sodium salicylate* | 1% | ++++ | |
| Sodium salicylate* | 0.5% | ++++ | |
| Control | 0% | ++++ | |

− no growth
+ slight growth
++ moderate growth
+++ heavy growth
++++ very heavy growth
*included as a positive control

Of the 21-substances tested against Aspergillus niger, as shown in Table 1, fourteen protected the medium for at least 14-days. Six of the substances protected the medium for less than seven days. One other substance gave seven day protection.

### EXAMPLE 2

Those substances that demonstrated significant anti-fungal activity in EXAMPLE 1 above were subjected to further testing in vitro on wet tanned cattlehide (wet blue). One inch square pieces of wet blue that had not been previously treated with fungicide were dipped in either 0.5% or 0.25% (by wt) mixtures of each active substance in water. Sodium omadine was included among the substances tested, as a positive control. The test organism, Aspergillus niger, was grown on potato dextrose agar for 5-days in petri-dishes. The wet blue pieces were placed on top of pieces of bent glass rod, thereby preventing direct contact with the “lawn” of Aspergillus niger. Thus, exposure of the wet blue to Aspergillus niger was limited to airborne spores, simulating one of the most common modes of exposure experienced in practice. For each active substance and concentration studied, wet blue pieces were suspended both grain side up and flesh side up. A bottom half of a petri-dish was used as a cover to provide a growth chamber for each sample. These growth chambers were incubated at 25° C. and evaluated weekly to determine the degree of fungal infestation on the wet blue surfaces.

TABLE 2
Antifungal efficacy of various treatments of wet blue
versus Aspergillus niger

| | CONCENTRATION | GROWTH | | | | | | |
|---|---|---|---|---|---|---|---|---|
| COMPOUND | (BY WT %) | Wk. 1 | Wk. 2 | Wk. 3 | Wk. 4 | Wk. 5 | Wk. 6 | Wk. 7 |
| Sodium lauryl sulfate | 0.5% (grain) | 0 | 0 | 0 | 0 | 0 | 0 | + |
| Sodium lauryl sulfate | 0.5% (flesh) | 0 | 0 | 0 | 0 | 0 | 0 | 0 |
| Sodium lauryl sulfate | 0.25% (grain) | 0 | 0 | 0 | 0 | 0 | 0 | ++ |
| Sodium lauryl sulfate | 0.25% (flesh) | 0 | 0 | 0 | 0 | 0 | 0 | ++ |
| Thyme oil | 0.5% (grain) | 0 | 0 | 0 | 0 | 0 | 0 | 0 |
| Thyme oil | 0.5% (flesh) | 0 | 0 | 0 | 0 | 0 | 0 | + |
| Thyme oil | 0.25% (grain) | 0 | 0 | 0 | 0 | 0 | 0 | + |
| Thyme oil | 0.25% (flesh) | 0 | 0 | 0 | 0 | 0 | 0 | 0 |
| Sodium omadine* | 0.05% (grain) | 0 | 0 | 0 | 0 | 0 | 0 | 0 |
| Sodium omadine* | 0.05% (flesh) | 0 | 0 | 0 | 0 | 0 | 0 | 0 |
| Control | 0% (grain) | 0 | 0 | 0 | +++ | ++++ | ++++ | ++++ |
| Control | 0% (grain) | 0 | 0 | 0 | ++ | ++++ | ++++ | ++++ |
| Control | 0% (flesh) | 0 | 0 | 0 | 0 | +++ | ++++ | ++++ |
| Control | 0% (flesh) | 0 | 0 | 0 | 0 | 0 | ++++ | ++++ |

0 no growth on surface
+ less than half of surface covered with mold
++ about half of surface covered with mold
+++ about ¾ of surface covered with mold
++++ the whole surface covered with mold
*Note: sodium omadine included as a positive control

Out of eleven fungicides that were tested against Aspergillus niger in petri-dishes, phenylethyl propionate, geraniol, peppermint oil, rosemary oil, cinnamon oil, eugenol, lemongrass oil, clove oil, and citronella all performed no better than the controls. Both sodium lauryl sulfate and thyme oil provided six to seven weeks protection—better than the controls at the concentration tested. Similarly, the positive control (i.e., a substance for which the anti-fungal activity is well established) protected the wet blue for seven weeks without any mold growth on the surface.

### EXAMPLE 3

Some of the minimum risk fungicides identified above were further tested against an industrial isolate of Penicillium sp, as shown in Table 3. This particular “wild strain” of Penicillium was isolated from commercial wet blue that was seriously contaminated with mold. In this case, the mold involved had caused considerable staining of the wet blue that resulted in significant loss in commercial value. Once again, one inch square pieces of wet blue were dipped in mixtures of active substances in water—this time at 1% and 0.5% concentrations. The mold exposure was carried out in petri-dishes as in EXAMPLE 2, but with Penicillium sp. as the test organism. Once again, the resistance of wet blue treated with either sodium lauryl sulfate or thyme oil was substantially improved over the unprotected controls. A commercial fungicide, Prosan™ 18, from Buckman Laboratories International, included as a positive control, also showed improvement over the control.

TABLE 3
Antifungal efficacy of various treatments of wet blue
versus Penicillium sp.

| | CONCENTRATION | GROWTH | | | | | | | |
|---|---|---|---|---|---|---|---|---|---|
| COMPOUND | (by wt. %) | Wk. 1 | Wk. 2 | Wk. 3 | Wk. 4 | Wk. 5 | Wk. 7 | Wk. 8 | Wk. 9 |
| Sodium lauryl sulfate | 1% (grain) | 0 | 0 | 0 | 0 | 0 | 0 | 0 | 0 |
| Sodium lauryl sulfate | 1% (flesh) | 0 | 0 | 0 | 0 | + | ++++ | ++++ | ++++ |
| Sodium lauryl sulfate | 0.5% (grain) | 0 | 0 | + | ++++ | ++++ | ++++ | ++++ | ++++ |
| Sodium lauryl sulfate | 0.5% (flesh) | 0 | 0 | 0 | + | ++ | ++++ | ++++ | ++++ |
| Thyme oil | 1% (grain) | 0 | 0 | 0 | 0 | 0 | 0 | 0 | 0 |
| Thyme oil | 1% (flesh) | 0 | 0 | 0 | 0 | 0 | 0 | 0 | 0 |
| Thyme oil | 0.5% (grain) | 0 | 0 | 0 | ++++ | ++++ | ++++ | ++++ | ++++ |
| Thyme oil | 0.5% (flesh) | 0 | 0 | 0 | 0 | 0 | + | ++ | ++ |
| Prosan ™ 18* | 0.03% (grain) | 0 | 0 | 0 | 0 | 0 | 0 | 0 | +++ |
| Prosan ™ 18* | 0.03% (flesh) | 0 | 0 | 0 | 0 | 0 | 0 | 0 | +++ |
| Control | 0% (grain) | 0 | 0 | ++ | ++++ | ++++ | ++++ | ++++ | ++++ |
| Control | 0% (grain) | 0 | 0 | +++ | ++++ | ++++ | ++++ | ++++ | ++++ |
| Control | 0% (flesh) | 0 | 0 | ++++ | ++++ | ++++ | ++++ | ++++ | ++++ |
| Control | 0% (flesh) | 0 | 0 | +++ | ++++ | ++++ | ++++ | ++++ | ++++ |

0 no growth on surface
+ less than half of surface covered with mold
++ about half of surface covered with mold
+++ about ¾ of surface covered with mold
++++ the whole surface covered with mold
*Note: Prosan ™ 18, from Buckman Laboratories International, included as a positive control

### EXAMPLE 4

In another example, 3 wt % sodium lauryl sulfate (90% concentration), 2 wt % thyme oil, and 0.1 wt % peppermint oil were mixed together with inert ingredients of 5 wt % sorbitol (70% concentration), 0.1 wt % xanthan gum, 20.0 wt % glycerine, and the balance water, to form a fungicide formulation that was effective to preserve and treat leather as in Example 3 above.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of preventing or inhibiting putrefaction, degradation, and/or deterioration of a surface of wet animal hide or skin, the method comprising applying a composition comprising at least one minimum risk fungicide to the surface or to a solid, liquid or gas that comes in contact with the surface, in an effective amount to inhibit or prevent putrefaction, degradation, and/or deterioration of said surface.

2. A method to control the growth of at least one fungus on a surface of a wet animal hide or skin, wherein said method comprises contacting said surface with at least one minimum risk fungicide, in an effective amount to control said growth.

3. The method of claim 2, wherein said fungus is at least one yeast.

4. The method of claim 2, wherein said fungus is at least one mold.

5. The method of claim 2, wherein said composition further comprises at least one non-minimum risk fungicide.

6. The method of claim 1, wherein the at least one minimum risk fungicide is castor oil, cedar oil, cinnamon, cinnamon oil, citric acid, citronella, citronella oil, cloves, clove oil, corn gluten meal, corn oil, cottonseed oil, dried blood, eugenol, garlic, garlic oil, geraniol, geranium oil, lauryl sulfate, lemongrass oil, linseed oil, malic acid, mint, mint oil, peppermint, peppermint oil, 2-phenylethyl propionate, potassium sorbate, putrescent whole egg solids, rosemary, rosemary oil, sesame, sesame oil, sodium chloride, sodium lauryl sulfate, soybean oil, thyme, thyme oil, white pepper, or zinc, or any combination thereof.

7. The method of claim 1, wherein the at least one minimum risk fungicide is phenylethyl propionate, garlic oil, geraniol, peppermint oil, rosemary oil, cinnamon oil, eugenol, citric acid, sodium lauryl sulphate, thyme oil, lemongrass oil, clove oil, citronella, or any combination thereof.

8. The method of claim 1, wherein the at least one minimum risk fungicide is sodium lauryl sulphate and/or thyme oil.

9. The method of claim 1, wherein the composition further comprises at least one inert ingredient.

10. The method of claim 1, wherein the composition is applied by dipping, spraying, spreading, rolling, roll-coating, soaking, dusting, sprinkling, fogging, vaporizing, gassing, or any combination thereof.

11. The method of claim 1, wherein the composition is applied to the surface prior to packaging for storage and/or shipment.

12. The method of claim 1, wherein the composition is applied to the surface by spraying or through a static diffuser.

13. The method of claim 1, wherein the minimum risk fungicide has a concentration of from about 0.1% to about 99.9% by weight of the composition.

14. The method of claim 1, wherein the composition is applied in an amount of from about 0.25 to about 100 pounds of said composition per about 3,000 pounds of wet hides or skins.

15. The method of claim 1, wherein the surface is treated with at least one non-minimum risk fungicide.

16. The method of claim 1, wherein the animal hides or skins are tanned.

17. A method of storing wet animal hides or skins by applying a fungicidal composition to a surface of the wet animal hides or skins and storing the wet animal hides or skins, wherein the fungicidal composition comprises at least one minimum risk fungicide that comprises castor oil, cedar oil, cinnamon, cinnamon oil, citric acid, citronella, citronella oil, cloves, clove oil, corn gluten meal, corn oil, cottonseed oil, dried blood, eugenol, garlic, garlic oil, geraniol, geranium oil, lauryl sulfate, lemongrass oil, linseed oil, malic acid, mint, mint oil, peppermint, peppermint oil, 2-phenylethyl propionate, potassium sorbate, putrescent whole egg solids, rosemary, rosemary oil, sesame, sesame oil, sodium chloride, sodium lauryl sulfate, soybean oil, thyme, thyme oil, white pepper, or zinc metal strips, or any combination thereof.

18. The method of claim 17, wherein the at least one minimum risk fungicide active is phenylethyl propionate, garlic oil, geraniol, peppermint oil, rosemary oil, cinnamon oil, eugenol, citric acid, sodium lauryl sulphate, thyme oil, lemongrass oil, clove oil, or citronella, or any combination thereof.

19. The method of claim 17, wherein the at least one minimum risk fungicide is sodium lauryl sulphate and/or thyme oil.

20. The method of claim 17, wherein the fungicidal composition further comprises at least one inert ingredient.

21. The method of claim 17, wherein the fungicidal composition is applied by dipping, spraying, spreading, rolling, roll-coating, soaking, dusting, sprinkling, fogging, gassing, or any combination thereof.

22. The method of claim 17, wherein the fungicidal composition is applied to the surface prior to packaging for storage and/or shipment.

23. The method of claim 17, wherein the fungicidal composition is applied to the surface by spraying or by a static diffuser.

24. The method of claim 17, wherein the minimum risk fungicide active ingredient has a concentration of from about 0.1 wt % to about 99.9 wt % by weight of said fungicidal composition, and a balanced concentration of at least one inert ingredient.

25. The method of claim 17, wherein the fungicidal composition is applied in an amount of from about 0.25 to about 100 pounds of fungicidal composition per about 3,000 pounds of wet hides or skins.

26. The method of claim 17, wherein the surface is treated with at least one non-minimum risk fungicide.

27. The method of claim 17, wherein the animal hides or skins are tanned.

28. The method of claim 17, further comprising storing said animal hides or skins for 1-7 days after application of the fungicidal composition without fungal growth.

29. The method of claim 17, further comprising storing said animal hides or skins for 7-14 days after application of the fungicidal composition without fungal growth.

30. The method of claim 17, further comprising storing said animal hides or skins for 1-8 weeks after application of the fungicidal composition without fungal growth.

31. The method of claim 17, further comprising storing said animal hides or skins for more than 8 weeks after application of the fungicidal composition without fungal growth.

32. A treated animal skin or hide comprising at least one wet animal skin or hide having a fungicide composition present on at least one surface thereof, wherein the fungicide composition comprises at least one minimum risk fungicide active ingredient that is castor oil, cedar oil, cinnamon, cinnamon oil, citric acid, citronella, citronella oil, cloves, clove oil, corn gluten meal, corn oil, cottonseed oil, dried blood, eugenol, garlic, garlic oil, geraniol, geranium oil, lauryl sulfate, lemongrass oil, linseed oil, malic acid, mint, mint oil, peppermint, peppermint oil, 2-phenylethyl propionate, potassium sorbate, putrescent whole egg solids, rosemary, rosemary oil, sesame, sesame oil, sodium chloride, sodium lauryl sulfate, soybean oil, thyme, thyme oil, white pepper, or zinc, or any combination thereof.

33. The treated animal skin or hide of claim 32, wherein the minimum risk fungicide is phenylethyl propionate, garlic oil, geraniol, peppermint oil, rosemary oil, cinnamon oil, eugenol, citric acid, sodium lauryl sulphate, thyme oil, lemongrass oil, clove oil, citronella, or any combination thereof.

34. The treated animal skin or hide of claim 32, wherein the minimum risk fungicide is sodium lauryl sulphate and/or thyme oil.

35. The treated animal skin or hide of claim 32, wherein the fungicidal composition further comprises at least one inert ingredient.

36. The treated animal skin or hide of claim 32, wherein the minimum risk fungicide has a concentration of about 0.1 wt % to about 99.9 wt % by weight of said fungicidal composition.

37. The treated animal skin or hide of claim 32, wherein the fungicidal composition is present in an amount of from about 0.25 to about 100 pounds per about 3,000 pounds of wet hides or skins.

38. The treated animal skin or hide of claim 32, further comprising at least one non-minimum risk fungicide present on said at least one surface.

39. The treated animal skin or hide of claim 32, wherein the animal hides or skins are tanned.
